(19) United States
(12) Patent Application Publication
(10) Pub. No.: US 2025/0162589 A1
(43) Pub. Date: May 22, 2025

(54) IMPROVED OVERTAKING MANEUVER FOR OVERTAKING A PRECEDING THIRD PARTY VEHICLE

(71) Applicant: VALEO SCHALTER UND SENSOREN GMBH, Bietigheim-Bissingen (DE)

(72) Inventor: Graziano Nardelli, Bietigheim-Bissingen (DE)

(73) Assignee: VALEO SCHALTER UND SENSOREN GMBH, Bietigheim-Bissingen (DE)

(21) Appl. No.: 18/841,681

(22) PCT Filed: Feb. 15, 2023
(86) PCT No.: PCT/EP2023/053723

§ 371 Date: Aug. 27, 2024

(30) Foreign Application Priority Data
Mar. 1, 2022 (DE) 10 2022 104 785.7

(51) Int. Cl. B60W 30/18; B60W 30/16

(52) U.S. Cl. CPC B60W 30/18163; B60W 30/16; B60W 2720/106

(57) ABSTRACT

The present invention refers to a method for performing pre-boost acceleration prior to overtaking a preceding third party vehicle (34) driving on a road (26) with multiple driving lanes (28, 30, 32) for driving in a forward driving direction (34) with an ego vehicle (10), wherein the ego vehicle (10) is following the preceding third party vehicle (36) on an ego lane (28) with an initial distance (d) to the ego vehicle (10), comprising the steps of detecting third party vehicles (38) on the neighboring driving lane (30), determining an acceleration profile with an acceleration phase for accelerating the ego vehicle (10) compared to the preceding third party vehicle (36) on the ego lane (28) while following the preceding third party vehicle (36), wherein an acceleration of the acceleration phase is determined based on the detection of third party vehicles (38) on the neighboring driving lane (30), a maximum acceleration value and a maximum change of acceleration, receiving a trigger for performing the pre-boost acceleration prior to overtaking the preceding third party vehicle (36) driving on the ego lane (28) using the neighboring driving lane (30), and performing the pre-boost acceleration according to the determined acceleration profile. The present invention also refers to a driving support system (12) for use in an ego vehicle (10) for following a preceding third party vehicle (36), in particular for performing adaptive cruise control, when driving on a road (26) with multiple driving lanes (28, 30, 32) for driving in a forward driving direction (34) of the ego vehicle (10), wherein the driving support system (12) is adapted to perform the method for pre-boost acceleration prior to overtaking a preceding third party vehicle (34) according to the above method.

The present invention refers to a method for performing pre-boost acceleration prior to overtaking a preceding third party vehicle driving on a road with multiple driving lanes for driving in a forward driving direction with an ego vehicle, wherein the ego vehicle is following the preceding third party vehicle on an ego lane with an initial distance to the ego vehicle.

The present invention also refers to a driving support system for use in an ego vehicle for following a preceding third party vehicle, in particular for performing adaptive cruise control, when driving on a road with multiple driving lanes for driving in a forward driving direction of the ego vehicle, wherein the driving support system is adapted to perform the method for pre-boost acceleration prior to overtaking a preceding third party vehicle.

Autonomous driving functions, which can also be partly implemented in current driving support systems, are becoming more and more important in state of the Art vehicles launched on the market. Such autonomous driving functions can increase general traffic safety, reduce occurrences of dangerous driving situations and help to reduce stress of human passengers or even a driver of the ego vehicle when driving.

In this context, autonomous driving functions and current driving support systems for highway driving are currently under development. This refers in general to driving scenarios when driving on road with multiple driving lanes for a driving direction, further referred to as highway driving scenarios. Such systems and features are currently provided e.g. as adaptive cruise control (ACC), which enable the ego vehicle to maintain a safety distance to the preceding third party vehicle and additionally to adapt its velocity in case no third party vehicle is detected ahead of the ego vehicle, which might be relevant for the ego vehicle for driving on a currently used driving lane.

In these highway driving scenarios, overtaking of third party vehicles ahead of the ego vehicle is an important issue, which has to be performed under consideration of the third party vehicle to be overtaken and additionally under consideration of traffic on a neighboring driving lane, also referred to as the overtaking lane, which has to be used by the ego vehicle at least during the overtaking maneuver of the third party vehicle on the ego lane. However, such implementations are rather static and limit possibilities to perform overtaking maneuvers, which may increase travelling time in case of preceding third party vehicles limiting the velocity of the ego vehicle.

In order to facilitate overtaking maneuvers, acceleration of the ego vehicle can be performed to increase a relative speed of the ego vehicle compared to the preceding third party vehicle. In this context, also pre-boost acceleration of the vehicle is known, which refers to acceleration of the vehicle prior to starting the overtaking maneuver itself. However, this can cause dangerous driving situations in case not handled properly.

In particular, it is difficult to adjust a velocity and/or acceleration of the ego vehicle when switching between different modes when performing the overtaking maneuver. This can happen when the ego vehicle changes from a follow mode for following the third party vehicle ahead of the ego vehicle on the ego lane to driving on the overtaking lane. Also, when starting or finishing the overtaking maneuver, changes in velocity and/or acceleration of the ego vehicle can be perceived as uncomfortable by occupants of the ego vehicle. Furthermore, it can happen frequently that an overtaking maneuver is started erroneously by the driver or that the overtaking maneuver has to be aborted because of traffic conditions, in particular when a third party driving on the overtaking lane moves with a slower velocity than the ego vehicle. In these cases, changes in velocity and/or acceleration of the ego vehicle can be required, which can also be perceived as uncomfortable by the occupants of the ego vehicle.

In this context, document US 2016/0009278 A1 refers to a system for the control of an actual speed for a vehicle, wherein the system is arranged to be able to carry out the control based on a manual control of the actual speed or based on an automatic control of the actual speed. An automatic control device is arranged to permit that the automatic control may actively control the actual speed to a higher value than a manual control device is arranged to permit the manual control to actively control the actual speed to.

Document US 2011/0196592 A1 refers to a method for operating an automatic speed control system of an automotive vehicle. Initially, in a normal follow mode, a setpoint distance between the vehicle and a preceding vehicle is set to a first valued, and a setpoint vehicle acceleration is into a first value a. Upon detection of an intention of the vehicle driver to overtake the preceding vehicle, such as switching on a turn indicator, the setpoint distance is reset to a second valued that is smaller. The setpoint acceleration may be reset to a second value simultaneously, or the second value may be set upon detection of initiation of a lane change into an overtaking lane, such as turning a steering wheel.

Document WO 2012/041869 A2 refers to a method for assisting a driver of a motor vehicle during an overtaking process. A distance between the motor vehicle and a vehicle travelling ahead is adjusted automatically to a first setpoint distance, and after an intention by the driver to overtake is detected at a starting time the distance is reduced. When the intention of the driver to overtake is detected and a safety function is in a predetermined range, an increased acceleration is initiated in order to reduce the distance.

It is an object of the present invention to provide a method for performing a pre-boost acceleration prior to overtaking a preceding third party vehicle as well as a driving support system for performing this method, which enable improved preparation of overtaking maneuvers, and which can be performed in a comfortable way for occupants of the ego vehicle.

This object is achieved by the independent claims. Advantageous embodiments are given in the dependent claims.

In particular, the present invention provides a method for performing pre-boost acceleration prior to overtaking a preceding third party vehicle driving on a road with multiple driving lanes for driving in a forward driving direction with an ego vehicle, wherein the ego vehicle is following the preceding third party vehicle on an ego lane with an initial distance to the ego vehicle, comprising the steps of detecting third party vehicles on the neighboring driving lane, determining an acceleration profile with an acceleration phase for accelerating the ego vehicle compared to the preceding third party vehicle on the ego lane while following the preceding third party vehicle, wherein an acceleration of the acceleration phase is determined based on the detection of third party vehicles on the neighboring driving lane, a maximum acceleration value and a maximum change of acceleration, receiving a trigger for performing the pre-boost acceleration prior to overtaking the preceding third party vehicle driving on the ego lane using the neighboring driving lane, and performing the pre-boost acceleration according to the determined acceleration profile.

The present invention also provides a driving support system for use in an ego vehicle for following a preceding third party vehicle, in particular for performing adaptive cruise control, when driving on a road with multiple driving lanes for driving in a forward driving direction of the ego vehicle, wherein the driving support system is adapted to perform the method for pre-boost acceleration prior to overtaking a preceding third party vehicle according to the above method.

The basic idea of the invention is to improve the pre-boost acceleration by determining the acceleration profile based on the detection of the third party vehicles on the neighboring driving lane prior to starting the overtaking maneuver. Accordingly, the pre-boost acceleration can be performed under application of the acceleration profile in a pre-defined way. The acceleration profile is determined based on the traffic on the neighboring driving lane as defined by the detected third party vehicles on the neighboring driving lane, as main external parameter. Furthermore, the maximum acceleration value and the maximum change of acceleration are provided as parameters defined in the ego vehicle, i.e. the driving support system of the ego vehicle. When the pre-boost acceleration phase finalizes, either the overtaking maneuver can be started, or the pre-boost acceleration ends without the overtaking maneuver. The acceleration applied during the acceleration phase can be constant or it can change during the acceleration phase. The change of acceleration can also be referred to as jerk. The initial distance can also be referred to as clearance distance.

The overtaking maneuver refers to a maneuver for overtaking a preceding third party vehicle driving on a road with multiple driving lanes ahead of the ego vehicle. The road has multiple driving lanes for at least one direction, so that two driving lanes can be used when performing the overtaking maneuver, one before the overtaking maneuver, i.e. the ego lane, and a neighboring driving line, which is used by the ego vehicle during the overtaking maneuver. The driving lanes are most typically driving lanes of a highway or a road outside city limits, which is a good choice for performing an overtaking maneuver. The ego lane and the neighboring driving lane can be driving lanes permanently designated to the same driving direction or for driving in different driving directions. In the last case, the neighboring driving lane is only used temporarily by the ego vehicle to perform the overtaking maneuver.

The neighboring driving lane can be a driving lane at the right or left side of the ego vehicle. Depending on national traffic regulations, just one of the neighboring driving lanes, either the neighboring driving lane at the right side or at the left side, or both can be allowed for overtaking.

The ego vehicle is any kind of vehicle including a motor bike, a truck, a lorry, a car or others. The ego vehicle is equipped with a driving support system, which can be part of or cooperate with an autonomous driving system, or which provides any kind of driving support to a human user of the ego vehicle. In particular, the driving support system performs a support for adaptive cruise control (ACC), which enables the ego vehicle to maintain a safety distance to the preceding third party vehicle and additionally to adapt its velocity in case no third party vehicle, which might be relevant for the ego vehicle for driving on a currently used driving lane, is detected ahead of the ego vehicle.

The overtaking maneuver is based on the ego vehicle following the preceding third party vehicle on the ego lane. The ego vehicle is typically following the preceding third party vehicle on the ego lane until the overtaking maneuver becomes possible. In this case, the two vehicles are driving essentially with the same velocity, and the ego vehicle keeps a distance to the preceding vehicle on the ego lane. However, the ego vehicle also follows the preceding third party vehicle on the ego lane, when the ego vehicle approaches the preceding third party vehicle on the ego lane and directly starts the overtaking maneuver. In this case, the approaching ego vehicle typically has a higher velocity than the preceding third party vehicle on the ego lane.

The initial distance between the ego vehicle and the preceding third party vehicle can refer to a required safety distance or any other suitable distance for following the preceding vehicle on the ego lane. The initial distance can be chosen arbitrarily. Furthermore, the initial distance can vary depending e.g. on a velocity of the two vehicles or others.

The trigger for performing the pre-boost acceleration prior to overtaking the preceding third party vehicle driving on the ego lane can be received in different ways. The trigger can be activated upon activation of a lane change indicator or a turning indicator operated by a human driver of the ego vehicle. Hence, the human driver indicates an intention to perform the overtaking maneuver for overtaking the preceding third party vehicle driving on the ego lane. Using the lane change indicator or the turning indicator preferably contains an indication to which side the overtaking maneuver will be performed. In case the road has at least one neighboring driving lane adjacent to the ego lane at both sides, the driving support system can select the correct neighboring driving lane for performing the overtaking maneuver, in particular in accordance with national traffic regulations. Alternatively, when performing autonomous driving, the trigger can be generated by a respective autonomous driving system of the ego vehicle, e.g. when the autonomous driving system decides to start an overtaking maneuver. In each case, pre-boost acceleration can be started as preparation of the subsequent overtaking maneuver.

Detecting third party vehicles on the neighboring driving lane is a step, which provides as a detection result information in respect to vehicles present on the respective neighboring driving lane. The information regarding the detected third party vehicles can be used differently, as further discussed. As already discussed above, in respect to the invention, it is important to use the information regarding the detected third party vehicles already for determining the acceleration profile for performing the pre-boost acceleration. The detection of the third party vehicles on the neighboring driving lane refers to a general detection of such vehicles. However, the detection of a particular third party vehicle on the neighboring driving lane can be a basis for deciding a preceding vehicle has to be followed also on the neighboring driving lane.

The acceleration phase refers to an acceleration of the ego vehicle still driving in the ego lane, i.e. prior to starting the overtaking maneuver and changing from the ego lane to the neighboring driving lane. Based on the pre-boost acceleration, the ego vehicle has an increased velocity when starting the overtaking maneuver and changing to the neighboring driving lane. In particular, the ego vehicle has a higher velocity than the preceding third party vehicle on the ego lane. The higher the velocity of the ego vehicle relative to the preceding third party vehicle, the shorter is an overall duration of the subsequent overtaking maneuver, which reduces risks of performing the overtaking maneuver. Therefore, the initial distance between the ego vehicle and the preceding third party vehicle shall allow such an acceleration without the ego vehicle coming to close to the preceding third party vehicle, i.e. maintaining a safety distance between the two vehicles.

In each case, any acceleration of the ego vehicle is defined for the acceleration profile under consideration of e.g. speed limits applicable, required safety distances between vehicles, maximum speed and/or acceleration of the ego vehicle and other possible restrictions applicable to the ego vehicle. Furthermore, a movement of the preceding third party vehicle on the ego lane is monitored. In case any change of driving parameters of the preceding third party vehicle is detected, this can result in an adaptation of parameters of the acceleration profile for performing the overtaking maneuver, in particular applicable velocities, and applicable accelerations.

The driving support system comprises one or more environment sensor(s) for monitoring an environment of the ego vehicle to detect the third party vehicles on the neighboring driving lane. The driving support system further comprises a processing unit for receiving and processing performing environment sensor information as provided from the environment sensor(s). Hence, the processing unit controls the overtaking maneuver. In an alternative embodiment, the detection of the third party vehicle on the neighboring driving lane can be performed based on information provided from infrastructure or from other vehicles using respective communication means. Such a flow of information is also referred to as vehicle-to-vehicle communication or vehicle-to-infrastructure communication. The overtaking maneuver can be controlled from the processing unit in such an alternative embodiment as discussed above.

According to a modified embodiment of the invention, detecting third party vehicles on the neighboring driving lane comprises receiving environment sensor information from at least one environment sensor provided at the ego vehicle, and detecting the third party vehicles on the neighboring driving lane based on the received environment sensor information from the at least one environment sensor. Based on the environment sensor information, the ego vehicle itself can monitor its environment and take all necessary decisions to perform the overtaking maneuver. Different kinds of environment sensors are known including optical cameras, LiDAR-based environment sensors, radar sensors, or ultrasonic sensors. In general, any kind of environment sensor can be suitable. The driving support system can comprise any suitable number and combination of environment sensors of the same kind or of different kinds. Preferably, the driving support system comprises environment sensors with a large detection range, which are arranged to detect the third party vehicles already at long distances ahead of the ego vehicle or behind the ego vehicle. Short range environment sensors can be in particular suitable to cover an area directly besides the ego vehicle. Furthermore, sensor information provided from multiple environment sensors is preferably fused in order to provide a single set of environment information, in particular to provide an environment map.

According to a modified embodiment of the invention, detecting third party vehicles on the neighboring driving lane comprises determining a position and/or a velocity of the detected third party vehicles on the neighboring driving lane, and determining the acceleration of the acceleration phase based on the detection of third party vehicles on the neighboring driving lane, a maximum acceleration value and a maximum change of acceleration comprises determining the acceleration based on the detection of the position and/or the velocity of the detected party vehicles on the neighboring driving lane. The position of the third party vehicles on the neighboring driving lane can indicate if the subsequent overtaking maneuver can be performed as indicated by the respective trigger, and accordingly if the pre-boost acceleration can be performed. Furthermore, already depending on the position(s) of the detected third party vehicle(s) on the neighboring driving lane, the acceleration of the acceleration phase can be determined in a suitable way for further performing the subsequent overtaking maneuver. However, when at least one third party vehicle is detected on the neighboring driving lane, based on the velocity of this vehicle, a further detailed determination can be performed to decide if and how the overtaking maneuver can be performed and if and how the pre-boost acceleration can be performed. Hence, knowing the velocity and the position of the vehicle(s), the acceleration of the acceleration phase can be determined with increased precision for further determining the acceleration profile.

According to a modified embodiment of the invention, determining the acceleration of the acceleration phase based on the detection of the third party vehicles on the neighboring driving lane, a maximum acceleration value and a maximum change of acceleration comprises applying a jerk limiter for limiting a change rate of the acceleration of the acceleration profile. The jerk limiter is applied to avoid discontinuities in the acceleration throughout the acceleration profile. This applies in particular to changes between the different phases as well as to the beginning and the end of the pre-boost acceleration according to the acceleration profile.

According to a modified embodiment of the invention, the method comprises a step of selecting a driving mode for driving on the neighboring driving lane as follower driving mode for following a third party vehicle detected on the neighboring driving lane or selecting a driving mode for driving on the neighboring driving lane as free driving mode with no third party vehicle detected on the neighboring driving lane, and the acceleration of the acceleration phase is determined under additional consideration of the selected driving mode. Upon lane change, the pre-boost acceleration terminates and a new logic takes over control. However, the acceleration phase of the acceleration profile can be determined so that a respective subsequent driving mode of the ego vehicle when performing the overtaking maneuver is considered. The driving mode is determined based on presence of a suitable third party vehicle detected on the neighboring driving lane for being followed, i.e. the third party vehicle is located at a suitable position with a suitable velocity. Based on the anticipation of the driving mode, a current acceleration of the ego vehicle can be preferably maintained at the beginning of the subsequent overtaking maneuver. In case no relevant third party vehicle has been detected on the neighboring driving lane, consequently no third party vehicle can be selected for following on the neighboring driving lane. A driving mode for free driving is defined for the acceleration profile, i.e. a non-follower mode, where the ego vehicle determines its driving parameters independently from third party vehicles in the surrounding in the subsequent overtaking maneuver. The driving parameters can be determined under consideration of e.g. a current speed limit and/or a configuration of the ego vehicle.

According to a modified embodiment of the invention, the step of determining an acceleration profile comprises determining the acceleration profile with a deceleration phase for decreasing the velocity of the ego vehicle compared to the preceding third party vehicle on the ego lane, wherein the deceleration phase is subsequent to the acceleration phase, wherein a deceleration of the deceleration phase is determined based on the preceding third party vehicle on the ego lane, a maximum deceleration value and a maximum change of acceleration with at least a minimum deceleration to keep at least a minimum distance to the preceding third party vehicle. When the pre-boost acceleration has to be aborted for any reason, in particular when the subsequent overtaking maneuver is aborted, the deceleration phase of the acceleration profile is determined to decrease the velocity of the ego vehicle compared to the preceding third party vehicle on the ego lane under consideration of the ego vehicle staying on the ego lane. Hence, the deceleration is determined to keep at least the minimum distance to the preceding third party vehicle, e.g. a safety distance. In order to provide a comfortable way of terminating the pre-boost acceleration, preferably a smooth transition is performed from the acceleration phase to the deceleration phase, in particular with a calibrated jerk. Parameters of the deceleration phase are preferably updated while the ego vehicle performs the pre-boost acceleration.

According to a modified embodiment of the invention, determining the acceleration profile with a deceleration phase comprises determining a current distance of the ego vehicle to the preceding third party vehicle on the ego lane and determining the deceleration phase based on the determined current distance of the ego vehicle to the preceding third party vehicle on the ego lane. In case the driver of the ego vehicle initiates an overtaking maneuver by generating the respective trigger, but does not change from the ego lane to the neighboring driving lane, the pre-boost acceleration cannot be continued due to the presence of the preceding third party vehicle on the ego lane. Hence, the deceleration phase is defined as fall-back. Based on the current distance, the termination of the pre-boost acceleration can be performed with a focus on a comfortable way of terminating the pre-boost acceleration, i.e. with a smaller deceleration, or with a focus of enabling the subsequent overtaking maneuver up to an ultimate moment, i.e. with a maximum deceleration of the deceleration phase.

According to a modified embodiment of the invention, the step of determining the deceleration of the deceleration phase based on the preceding third party vehicle on the ego lane, a maximum deceleration value and a maximum change of acceleration with at least a minimum deceleration to keep at least a minimum distance to the preceding third party vehicle comprises determining the deceleration of the deceleration phase based on passive braking, e.g. a deceleration performed using engine breaking of the ego vehicle, a deceleration based on air resistance and/or rolling resistance of the ego vehicle, and/or a deceleration based on energy recuperation performed with the ego vehicle, or based on active braking, i.e. using a conventional braking system of the ego vehicle. The different means for achieving the deceleration enable a more comfortable way or a more efficient way of terminating the acceleration phase of the acceleration profile based on the different deceleration intensities. Active or passive braking as well as details in respect to the deceleration can be chosen depending on different parameters. Most important is a remaining distance between the ego vehicle and the preceding third party vehicle on the ego lane. Other parameters can be an energy availability, e.g. to limit overall consumption of the ego vehicle. Furthermore, for ecologic reasons, deceleration based on energy recuperation can be preferred to other passive braking methods and in particular to active braking.

According to a modified embodiment of the invention, the step of determining the deceleration of the deceleration phase based on the preceding third party vehicle on the ego lane, a maximum deceleration value and a maximum change of acceleration with at least a minimum deceleration to keep at least a minimum distance to the preceding third party vehicle comprises determining the deceleration as a minimum deceleration to reach a minimum distance with a target velocity smaller than the velocity of the preceding third party vehicle on the ego lane with a predefined relative velocity offset. When the velocity of the ego vehicle is smaller than the velocity of the preceding third party vehicle at the end of the deceleration phase, the ego vehicle can return e.g. to its initial position or to any other position further behind the preceding third party vehicle without further actions to be taken by just maintaining its velocity. This is considered as a highly comfortable way of increasing the distance to the preceding third party vehicle.

According to a modified embodiment of the invention, the step of determining an acceleration profile comprises determining the acceleration profile with a return phase for returning with the ego vehicle into a driving modus for following the preceding third party vehicle on the ego lane with the initial distance between the ego vehicle and the preceding third party vehicle on the ego lane, wherein the return phase is subsequent to the deceleration phase. As discussed above, the ego vehicle has a velocity smaller than the velocity of the preceding third party vehicle on the ego lane at the end of the deceleration phase. The return phase is defined to return the ego vehicle from its current position behind the preceding third party vehicle with a current distance to the preceding third party vehicle on the ego lane back to a position, where the ego vehicle has the initial distance to the preceding third party vehicle on the ego lane.

According to a modified embodiment of the invention, the method comprises performing a continuous recalculation of the acceleration and/or deceleration of the acceleration profile, in particular after expiry of a given time period. Hence, the acceleration profile is continuously updated based on current traffic conditions. Accordingly, the acceleration profile is always up to date and can be applied immediately after having received the trigger for performing the overtaking maneuver of the preceding third party vehicle driving on the ego lane. Changes in distances between the vehicles and/or velocities of the vehicles can be immediately considered. The continuous recalculation can be performed based on a given time interval, e.g. every 20 ms. The continuous recalculation is preferably performed also after having started pre-boost acceleration, so that changes in the vehicles in the environment can be considered. When performing the recalculation, a jerk limitation is applied to avoid high jerks when applying the recalculated acceleration profile.

Feature and advantages described above with reference to the inventive method apply equally to the inventive driving support system and vice versa. Furthermore, the individual method steps described above can be performed in different sequences compared to the above description. The above description is given by way of example without excluding other sequences of the described method.

These and other aspects of the invention will be apparent from and elucidated with reference to the embodiments described hereinafter. Individual features disclosed in the embodiments can constitute alone or in combination an aspect of the present invention. Features of the different embodiments can be carried over from one embodiment to another embodiment.

In the drawings:

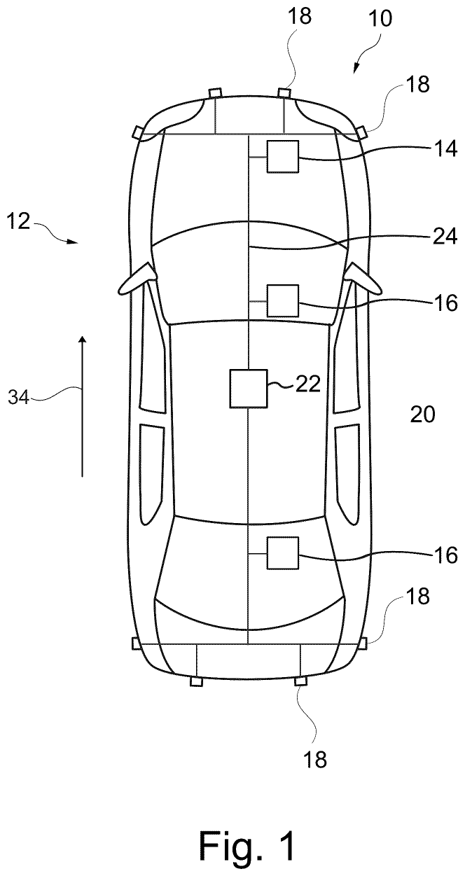

FIG. 1 shows a schematic view of an ego vehicle with a driving support system comprising multiple environment sensors and a processing unit, which are connected via a data connection, according to a first, preferred embodiment,

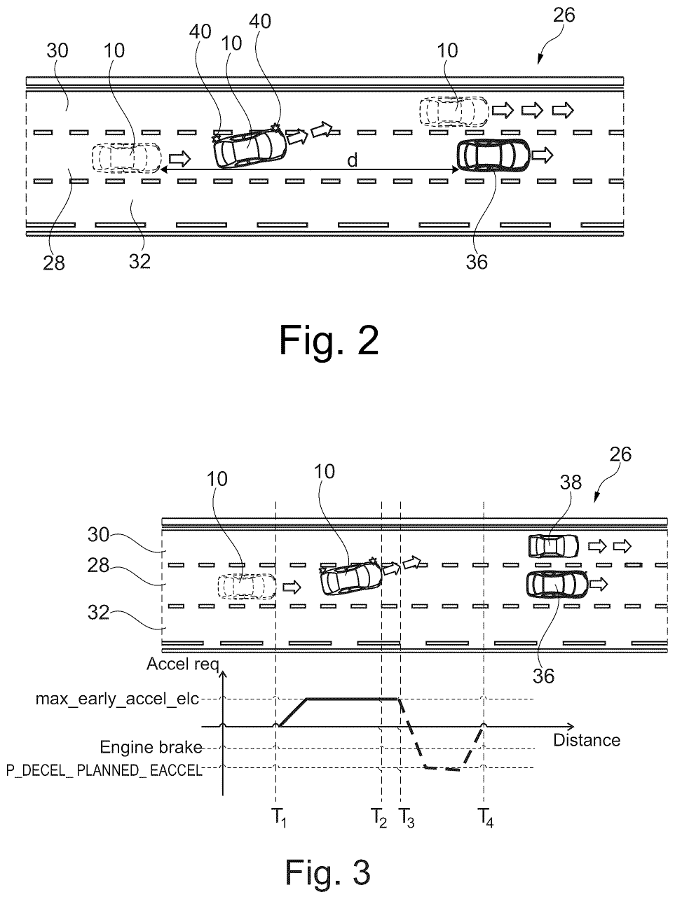

FIG. 2 shows a schematic drawing of a general overtaking maneuver of the ego vehicle of FIG. 1 driving on a road with multiple driving lanes and following a preceding third party vehicle in accordance with the first embodiment,

FIG. 3 shows a schematic drawing indicating a first example of a pre-boost acceleration, when a subsequent overtaking maneuver of the ego vehicle of FIG. 1 is started in accordance with the first embodiment,

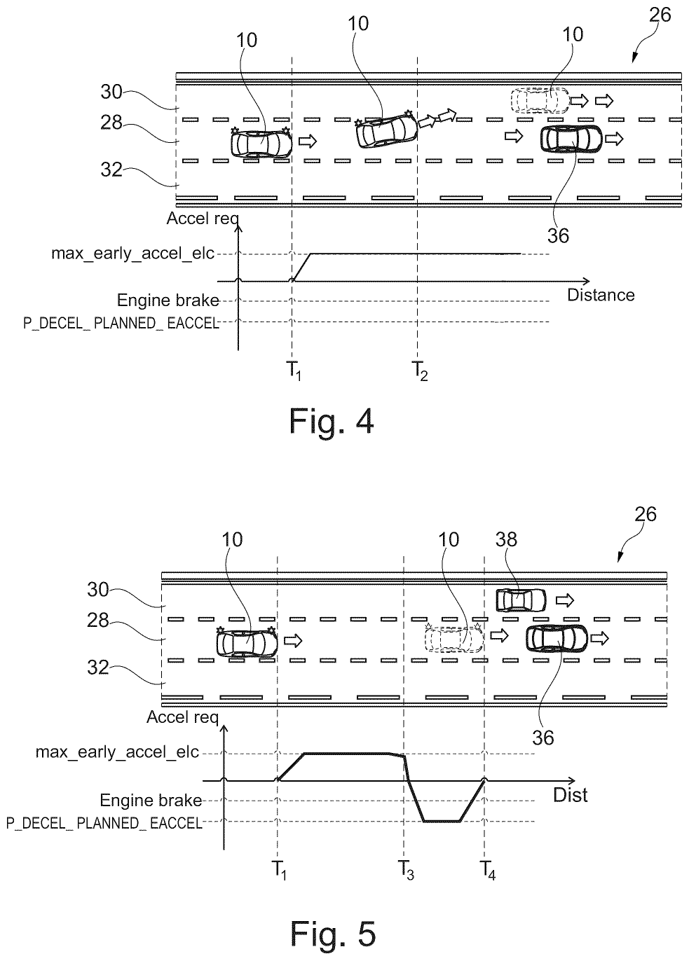

FIG. 4 shows a schematic drawing indicating a second example of a pre-boost acceleration, when a subsequent overtaking maneuver of the ego vehicle of FIG. 1 is started and a subsequent overtaking maneuver is performed, in accordance with the first embodiment,

FIG. 5 shows a schematic drawing indicating a third example of a pre-boost acceleration including acceleration phase and deceleration phase in accordance with the first embodiment,

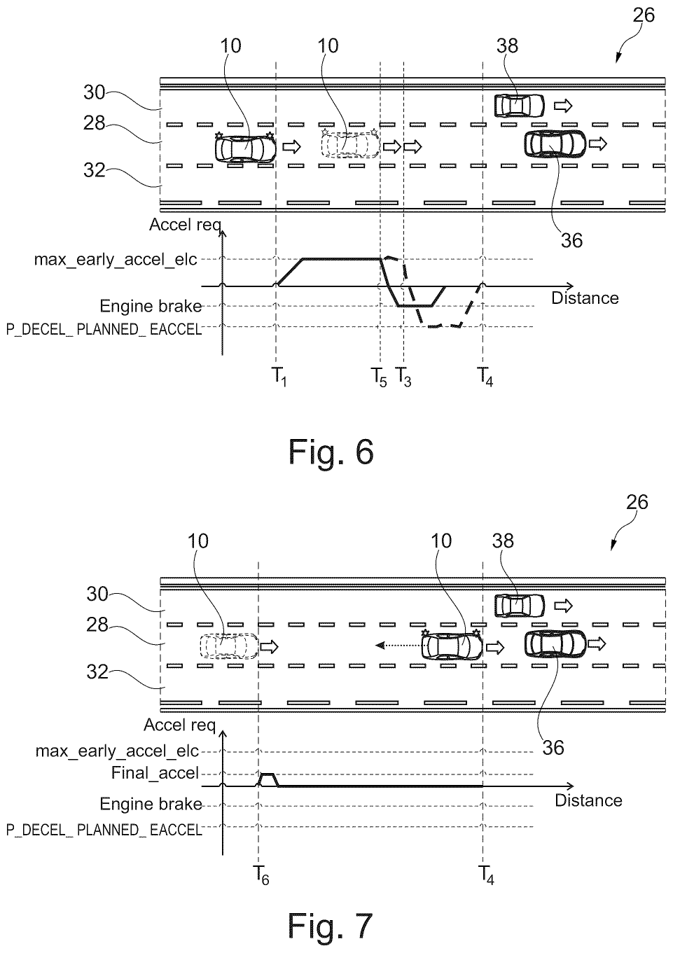

FIG. 6 shows a schematic drawing indicating a fourth example of a pre-boost acceleration including acceleration phase and deceleration phase in accordance with the example of FIG. 5 with a modified acceleration and deceleration phase,

FIG. 7 shows a schematic drawing indicating a fifth example of a pre-boost acceleration including a return phase in accordance with the first embodiment,

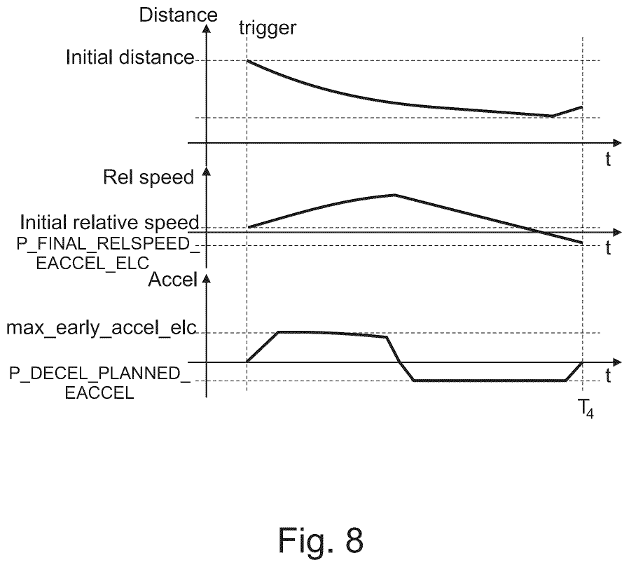

FIG. 8 shows a course of the acceleration, velocity and travelled distance in accordance with the third example shown in FIG. 5, and

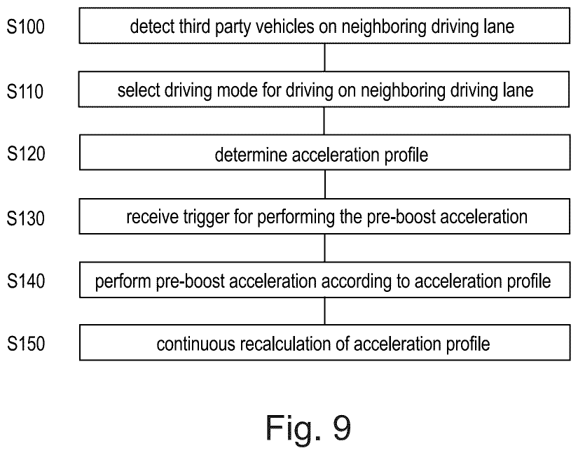

FIG. 9 shows a flow chart of a method for performing pre-boost acceleration prior to overtaking a preceding third party vehicle driving on a road with multiple driving lanes for driving in a forward driving direction with an ego vehicle, wherein the ego vehicle is following the preceding third party vehicle on an ego lane with an initial distance to the ego vehicle, in accordance with the first embodiment.

FIG. 1 shows an ego vehicle 10 comprising a driving support system 12, which provides driving support for a human driver, according to a first, preferred embodiment. The ego vehicle 10 can be any kind of vehicle, e.g. a passenger car, a truck or a motor bike, which is driven by the human driver.

The driving support system 12 provides assistance to the human driver of the ego vehicle 10. It can be a driving support system 12, which provides additional kinds of driving support, or which only provides support for performing an overtaking maneuver as discussed below in detail. Such driving support systems 12 are also known as driver assistance systems, which are frequently referred to as ADAS (Advanced Driver Assistance Systems). In this embodiment, the driving support system 12 is adapted for performing adaptive cruise control (ACC), which enables the ego vehicle 10 to maintain a safety distance to other vehicles and additionally to adapt its velocity in case no other vehicles, which might be relevant for the ego vehicle 10, are detected ahead of the ego vehicle 10.

The driving support system 12 comprises in this embodiment a set of environment sensors 14, 16, 18 for monitoring an environment 20 of the ego vehicle 10. The environment sensors 14, 16, 18 comprise a LiDAR-based environment sensor 14, an optical camera 16 and multiple ultrasonic sensors 18. The environment sensors 14, 16, 18 recognize the environment 20 of the ego vehicle 10. The environment sensors 14, 16, 18 generate sensor information, which can comprise raw data or pre-processed data.

The ego vehicle 10 of the first embodiment further comprises a processing unit 22 and a data connection 24, which interconnects the environment sensors 14, 16, 18 and the processing unit 22. The processing unit 22 can be any kind of processing unit 22 suitable for the use in the ego vehicle 10. Such processing units 22 are typically known as ECU (electronic control unit) in the automotive area. The processing unit 22 can be shared for performing multiple tasks or applications. The processing unit 22 receives and processes the sensor information provided from the environment sensors 14, 16, 18.

The data connection 24 can be a dedicated connection between the environment sensors 14, 16, 18 and the processing unit 22 or a data bus. Furthermore, the data connection 24 can be a shared data connection 24 used by different kinds of devices of the ego vehicle 10, e.g. a multi-purpose data bus. The data connection 24 can be implemented e.g. as CAN-bus, LIN-bus, or others.

Although a single data connection 24 is depicted in FIG. 1, multiple connections or data busses can be provided in parallel for connecting the environment sensors 14, 16, 18 to the processing unit 22, and which are considered together as data connection 24. The sensor information from the environment sensors 14, 16, 18 is transferred to the processing unit 22 via the data connection 24. Similarly, although a single processing unit 22 is depicted in FIG. 1, multiple processing units 22 can be provided in parallel for processing the environment sensor information from the environment sensors 14, 16, 18. According to the first embodiment, the processing unit 22 fuses the environment sensor information received from the environment sensors 14, 16, 18 to provide a single set of environment information, in particular to provide an environment map.

Subsequently will be described a method for performing pre-boost acceleration prior to overtaking a preceding third party vehicle 36 according to the first embodiment. The pre-boost acceleration performed using the ego vehicle 10 of FIG. 1 is depicted in a general way in FIG. 2.

As can be seen in FIG. 2, the ego vehicle 10 is driving on a road 26 with multiple driving lanes 28, 30, 32 for driving in a forward driving direction 34. The ego vehicle 10 is driving on an ego lane 28 and following a preceding third party vehicle 36 with an initial distance d. The ego vehicle 10 performs pre-boost acceleration prior to the overtaking maneuver by using a driving lane 28, 30, 32 at a left side of the ego vehicle 10, which is a neighboring driving lane 30. The driving lane 28, 30, 32 at a right side of the ego vehicle 10 is not used in the overtaking maneuver and is considered as further lateral driving lane 32. The driving lanes 28, 30, 32 are driving lanes 28, 30, 32 of a highway or a road outside city limits. The driving lanes 28, 30, 32 are permanently designated to the same driving direction.

When performing the pre-boost acceleration prior to the overtaking maneuver, the ego vehicle 10 first accelerates, thereby reducing the distance to the preceding third party vehicle 36 on the ego lane 28. The ego vehicle 10 catches up with the preceding third party vehicle 36, until the overtaking maneuver starts and the ego vehicle 10 changes to the neighboring driving lane 30. The ego vehicle 10 passes the preceding third party vehicle 36 and preferably changes back to the ego lane 28.

Below will be described a detailed method for performing pre-boost acceleration prior to the overtaking maneuver according to the first embodiment. A flow chart of the method is shown in FIG. 9. FIGS. 3 and 4 show driving examples when executing the method according to the first embodiment.

As a precondition, the ego vehicle 10 is driving as discussed above in respect to FIG. 2 on the road 26 with the three driving lanes 28, 30, 32 and following the preceding third party vehicle 36 with the initial distance d. The initial distance d can vary depending e.g. on a velocity of the ego vehicle 10 and the preceding third party vehicle 36 or others. The ego vehicle 10 follows the preceding third party vehicle 36 on the ego lane 28 until the overtaking maneuver becomes possible. Hence, the ego vehicle 10 and the preceding third party vehicle 36 are driving essentially with the same velocity with the initial distance d on the ego lane 28.

The method starts with step S100, which refers to detecting third party vehicles 38 on the neighboring driving lane 30.

Accordingly, environment sensor information from the environment sensors 14, 16, 18 provided at the ego vehicle 10 is received. The environment sensor information covers the environment 20 of the ego vehicle 10 and includes information in respect to the third party vehicles 38 present on the neighboring driving lane 30 as detection results. Fusion of the environment sensor information received from the different environment sensors 14, 16, 18 is performed as described above. A position and a velocity of the third party vehicles 38 on the neighboring driving lane 30 are provided as detection of the third party vehicle 38 on the neighboring driving lane 30.

Detecting third party vehicles 38 on the neighboring driving lane 30 is a step, which provides as a detection result information in respect to vehicles present on the neighboring driving lane 30. The detection of the third party vehicles 38 on the neighboring driving lane 30 refers to a general detection of such vehicles and can result in no third party vehicle 38 present on the neighboring driving lane 30.

Step S110 refers to selecting a driving mode for driving on the neighboring driving lane 30 as follower driving mode for following a third party vehicle 38 detected on the neighboring driving lane 30 or selecting a driving mode for driving on the neighboring driving lane 30 as free driving mode with no third party vehicle detected 38 on the neighboring driving lane 30. The driving mode is determined based on presence of a suitable third party vehicle 38 detected on the neighboring driving lane 30 for being followed, i.e. the third party vehicle 38 is located at a suitable position with a suitable velocity. In case no relevant third party vehicle 38 has been detected on the neighboring driving lane 30, consequently no third party vehicle 38 can be selected for following on the neighboring driving lane 30. A driving mode for free driving is defined, i.e. a non-follower mode, where the ego vehicle 10 determines its driving parameters independently from third party vehicles 38. The driving mode corresponds to a driving mode as determined also during the subsequent overtaking maneuver.

Step S120 refers to determining an acceleration profile with an acceleration phase for accelerating the ego vehicle 10 compared to the preceding third party vehicle 36 on the ego lane 28 while following the preceding third party vehicle 36, wherein an acceleration of the acceleration phase is determined based on the detection of third party vehicles 38 on the neighboring driving lane 30, a maximum acceleration value and a maximum change of acceleration. The acceleration of the acceleration phase is determined under additional consideration of the detection of the position and/or the velocity of the detected party vehicles 38 on the neighboring driving lane 30 and of the selected driving mode as determined in step S110 based on the detection of third party vehicles 38 on the neighboring driving lane 30.

The acceleration phase refers to an acceleration of the ego vehicle 10 driving on the ego lane 28, i.e. prior to starting the overtaking maneuver and changing from the ego lane 28 to the respective neighboring driving lane 30. Based on the pre-boost acceleration, the ego vehicle 10 has an increased velocity when starting the overtaking maneuver and changing to the neighboring driving lane 30 compared to a current velocity. In particular, the ego vehicle 10 has a higher velocity than the preceding third party vehicle 36 on the ego lane 28 based on the pre-boost acceleration.

The acceleration profile is determined with an additional deceleration phase for decreasing the velocity of the ego vehicle 10 compared to the preceding third party vehicle 36 on the ego lane 28. The deceleration phase is subsequent to the acceleration phase. A deceleration of the deceleration phase is determined based on the preceding third party vehicle 36 on the ego lane 28, a maximum deceleration value and a maximum change of acceleration with at least a minimum deceleration to keep at least a minimum distance to the preceding third party vehicle 36, and a current distance of the ego vehicle 10 to the preceding third party vehicle 36 on the ego lane 28. Hence, the current distance of the ego vehicle 10 to the preceding third party vehicle 36 on the ego lane 28 is determined.

The deceleration phase of the acceleration profile is determined to decrease the velocity of the ego vehicle 10 compared to the preceding third party vehicle 36 on the ego lane 28 under consideration of the ego vehicle 10 staying on the ego lane 28, e.g. when the pre-boost acceleration is aborted for any reason, e.g. when the subsequent overtaking maneuver is aborted. Hence, the deceleration is determined to keep at least the minimum distance to the preceding third party vehicle 36 on the ego lane 28, e.g. a safety distance.

The deceleration of the deceleration phase is determined based on passive braking, e.g. a deceleration performed using engine breaking of the ego vehicle 10, a deceleration based on air resistance and/or rolling resistance of the ego vehicle 10, and/or a deceleration based on energy recuperation performed with the ego vehicle 10, or based on active braking, i.e. using a conventional braking system of the ego vehicle 10. The different means for achieving the deceleration enable a comfortable way and an efficient way of decelerating the ego vehicle 10 based on different deceleration intensities.

The deceleration is still further determined as a minimum deceleration to reach a minimum distance with a target velocity smaller than the velocity of the preceding third party vehicle 36 on the ego lane 28 with a predefined relative velocity offset. Hence, at the end of the deceleration phase, the velocity of the ego vehicle 10 is below the velocity of the preceding third party vehicle 36 on the ego lane 28. Accordingly, the ego vehicle 10 can return e.g. to its initial position or to any other position further behind the preceding third party vehicle 36 on the ego lane 28 without further actions to be taken by just maintaining its velocity.

When having reached the end of the return phase, the ego vehicle 10 can return into the driving modus for following the preceding third party vehicle 36 on the ego lane 28 with the initial distance d between the ego vehicle 10 and the preceding third party vehicle 36 on the ego lane 28. Hence, the return phase is subsequent to the deceleration phase. As discussed above, the ego vehicle 10 has a velocity lower than the velocity of the preceding third party vehicle 36 on the ego lane 28 at the end of the deceleration phase and returns from its current position behind the preceding third party vehicle 36 with a current distance to the preceding third party vehicle 36 on the ego lane 28 back to the position with the initial distance d to the preceding third party vehicle 36 on the ego lane 28 by just maintaining its velocity.

The acceleration and deceleration of the entire acceleration profile is determined under application of a jerk limiter for limiting a change rate of the acceleration/deceleration of the ego vehicle 10. The jerk limiter is applied to avoid discontinuities in the acceleration throughout the acceleration profile. This applies to changes between the different phases of the acceleration profile as well as to the beginning and the end of the pre-boost acceleration according to the acceleration profile.

In each case, any acceleration of the ego vehicle 10 is defined for the acceleration profile under consideration of e.g. speed limits applicable, required safety distances between vehicles, maximum speed and/or acceleration of the ego vehicle 10 and other possible restrictions applicable to the ego vehicle 10. Driving parameters are determined under consideration of e.g. a current speed limit and/or a configuration of the ego vehicle 10.

Step S130 refers to receiving a trigger for performing the pre-boost acceleration prior to overtaking the preceding third party vehicle 36 driving on the ego lane 28 using the neighboring driving lane 30. The trigger can be received in different ways. The trigger can be activated e.g. upon activation of a lane change indicator or a turning indicator operated by a human driver of the ego vehicle 10, which contains an indication to which side the overtaking maneuver will be performed. Hence, the human driver indicates an intention to perform the overtaking maneuver for overtaking the preceding third party vehicle 36 driving on the ego lane 28. Alternatively, when performing autonomous driving, the trigger can be generated by a respective autonomous driving system of the ego vehicle 10, e.g. when the autonomous driving system decides to start an overtaking maneuver.

Step S140 refers to performing the pre-boost acceleration according to the determined acceleration profile. The acceleration according to the acceleration profile is applied to the ego vehicle 10.

Step S150 refers to performing a continuous recalculation of the acceleration and deceleration of the acceleration profile, in particular after expiry of a given time period. Hence, the acceleration profile is continuously updated based on current traffic conditions, so that the acceleration profile is always up to date and can be applied immediately. Changes in distances between the ego vehicle 10 and the preceding third party vehicle 36 on the ego lane 28 and/or between the ego vehicle 10 and further third party vehicles 38 on the neighboring driving lane 30 as well as velocities of the respective vehicles 10, 36, 38 are immediately considered for providing the acceleration profile. The continuous recalculation is performed based on a given time interval, e.g. every 20 ms. The continuous recalculation is continued after having started pre-boost acceleration. Also when performing the recalculation, the jerk limitation is applied to avoid high jerks when applying the recalculated acceleration profile compared to a previous.

In each case, any acceleration and/or deceleration of the ego vehicle 10 is defined for the acceleration profile under consideration of e.g. speed limits applicable, required safety distances between vehicles 10, 36, 38, maximum speed and/or acceleration of the ego vehicle 10 and other possible restrictions applicable to the ego vehicle 10.

The examples of FIGS. 3 to 7 show different driving scenes and a corresponding course of the acceleration according to the acceleration profile, which has been determined based on the method described above. Additionally, points of time T₁ to T₆ are marked to indicate a sequence of the different phases of the acceleration profile, which can be performed during the described pre-boost acceleration.

A first example with the ego vehicle 10 starting the follower driving mode for following the third party vehicle 38 after the acceleration phase is shown in FIG. 3. The acceleration profile is determined as described above. At time T₁, the overtaking maneuver is triggered and the acceleration phase, which lasts until time T₃, as indicated by the continuous line, is started. Accordingly, the ego vehicle 10 starts accelerating on the ego lane 28, while still following the preceding third party vehicle 36 on the ego lane 28, i.e. the ego vehicle 10 is in follower driving mode. At time T₂, the pre-boost acceleration finishes, since the ego vehicle 10 starts the overtaking maneuver by changing to the neighboring driving lane 30. The remainder of the acceleration phase between time T₂ and time T₃ is not executed anymore. The deceleration phase of the acceleration profile between time T₃ and time T₄, as indicated by the dashed line, is not started, since the pre-boost acceleration is stopped upon start of the overtaking maneuver.

A second example with the ego vehicle 10 performing an overtaking maneuver after the acceleration phase is shown in FIG. 4. Since no third party vehicle 38 is present on the neighboring driving lane 30, the acceleration of the acceleration phase is determined for free driving mode on the neighboring driving lane 30 with the maximum acceleration max_early:acceleration_elc. As described above with respect to the example shown in FIG. 3, at time T₁, the pre-boost acceleration is started with the acceleration phase. The ego vehicle 10 starts accelerating on the ego lane 28 while following the preceding third party vehicle 36 on the ego lane 28. At time T₂, the pre-boost acceleration terminates and the ego vehicle 10 starts the overtaking maneuver by starting to change from the ego lane 28 to the neighboring driving lane 30. The ego vehicle 10 selects the free driving mode given that no third party vehicle 38 has been detected on the neighboring driving lane 30, as also determined for the pre-boost acceleration. Accordingly, the ego vehicle 10 changes from its follower mode for following the preceding third party vehicle 36 to the free driving mode and further accelerates independently from third party vehicles 36, 38 on the ego lane 28 or the neighboring driving lane 30. In this example, the ego vehicle 10 continues accelerating with the same acceleration already applied during pre-boost acceleration, since the acceleration of the acceleration phase has been determined in a similar way as applied for the subsequent overtaking maneuver.

A third example in accordance with the above-described method and performed with the ego vehicle 10 is indicated in FIG. 5. At time T₁, the pre-boost acceleration is triggered and the acceleration phase is started, as discussed already in respect to the examples of FIGS. 3 and 4. The ego vehicle 10 starts accelerating on the ego lane 28 according to the acceleration profile with the applied jerk limitation. The ego vehicle 10 still follows the preceding third party vehicle 36 on the ego lane 28.

In the third example shown in FIG. 5, e.g. due to the third party vehicle 38 driving on the neighboring driving lane 30, the ego vehicle does not change to the neighboring driving lane 30 to start the overtaking maneuver. Accordingly, the acceleration phase finishes at time T₃ and the deceleration phase of the acceleration profile is started with a negative acceleration applied to prevent the ego vehicle 10 from approaching the preceding third party vehicle 36 on the ego lane 28 too close.

In the third example shown in FIG. 5, the deceleration phase is based on active braking, i.e. using a conventional braking system of the ego vehicle 10. The deceleration is determined to keep the minimum distance to the preceding third party vehicle 36 on the ego lane 28, e.g. a safety distance, which is reached at time T₄. The minimum distance to the preceding third party vehicle 36 on the ego lane 28 is reached at time T₄ with a target velocity with a predefined relative velocity offset of approximately 5 km/h below the velocity of the preceding third party vehicle 36 on the ego lane 28. In addition, FIG. 8 shows the acceleration as indicated in FIG. 5 together with the corresponding relative velocity of the ego vehicle 10 compared to the preceding third party vehicle 36 on the ego lane 28 and the distance between the ego vehicle 10 and the preceding third party vehicle 36 on the ego lane 28.

Subsequently, the return phase for returning with the ego vehicle 10 into a follower mode for following the preceding third party vehicle 36 on the ego lane 28 with the initial distance d to the ego vehicle 10 is performed, which is shown in FIG. 7. The acceleration/deceleration has already been reduced to zero at the end of the deceleration phase, so that the ego vehicle 10 falls more and more behind the preceding third party vehicle 36 on the ego line 28 based on its lower velocity due to the relative velocity offset. The return phase is finalized at time T₆, when the ego vehicle 10 has reached the initial distance d behind the preceding third party vehicle 36 on the ego line 28. The finalization of the return phase includes a short acceleration just before reaching the initial distance d behind the preceding third party vehicle 36 on the ego line 28 to increase the velocity of the ego vehicle 10 to be identical to the velocity of the preceding third party vehicle 36 on the ego line 28. The ego vehicle 10 returns to follower mode for following the preceding third party vehicle 36 on the ego line 28.

A fourth example in accordance with the method of the second embodiment as performed with the ego vehicle 10 is depicted in FIG. 6. The fourth example is almost identical to the third example and shown in comparison together with the example of FIG. 5. However, the acceleration phase already ends at time T₅ prior to time T₃, since the deceleration the deceleration phase of the fourth example is based on passive braking, which is performed using an engine brake of the ego vehicle 10. Hence, a smaller deceleration is applied compared to the example of FIG. 5. The subsequent return phase is also performed as shown in FIG. 7.

### REFERENCE SIGNS LIST

10 ego vehicle
12 driving support system
14 LiDAR-based environment sensor, environment sensor
16 optical camera, environment sensor
18 ultrasonic sensor, environment sensor
20 environment
22 processing unit
24 data connection
26 road
28 driving lane, ego lane
30 driving lane, neighboring driving lane
32 driving lane, further lateral driving lane
34 forward driving direction
36 preceding third party vehicle
38 third party vehicle on neighboring driving lane
40 lane change indicator or turning indicator
d initial distance

1. A method for performing pre-boost acceleration prior to overtaking a preceding third party vehicle driving on a road with multiple driving lanes for driving in a forward driving direction with an ego vehicle, wherein the ego vehicle is following the preceding third party vehicle on an ego lane with an initial distance to the ego vehicle, the method comprising:
detecting third party vehicles on the neighboring driving lane;
determining an acceleration profile with an acceleration phase for accelerating the ego vehicle compared to the preceding third party vehicle on the ego lane while following the preceding third party vehicle,
wherein an acceleration of the acceleration phase is determined based on the detection of third party vehicles on the neighboring driving lane, a maximum acceleration value and a maximum change of acceleration;
receiving a trigger for performing the pre-boost acceleration prior to overtaking the preceding third party vehicle driving on the ego lane using the neighboring driving lane; and
performing the pre-boost acceleration according to the determined acceleration profile.

2. The method according to claim 1, characterized in that further comprising:
detecting third party vehicles on the neighboring driving lane comprises
receiving environment sensor information from at least one environment sensor provided at the ego vehicle, and
detecting the third party vehicles on the neighboring driving lane based on the received environment sensor information from the at least one environment sensor.

3. The method according to claim 1, further comprising:
detecting third party vehicles on the neighboring driving lane comprises determining a position and/or a velocity of detected third party vehicles on the neighboring driving lane, and
determining the acceleration of the acceleration phase based on the detection of third party vehicles on the neighboring driving lane, a maximum acceleration value and a maximum change of acceleration comprises determining the acceleration based on the detection of the position and/or the velocity of the detected party vehicles on the neighboring driving lane.

4. The method according to claim 1, further comprising:
determining the acceleration of the acceleration phase based on the detection of the third party vehicles on the neighboring driving lane, a maximum acceleration value and a maximum change of acceleration comprises
applying a jerk limiter for limiting a change rate of the acceleration of the acceleration profile.

5. The method according to claim 1, further comprising:
selecting a driving mode for driving on the neighboring driving lane as follower driving mode for following a third party vehicle detected on the neighboring driving lane or selecting a driving mode for driving on the neighboring driving lane as free driving mode with no third party vehicle detected on the neighboring driving lane, and the acceleration of the acceleration phase is determined under additional consideration of the selected driving mode.

6. The method according to claim 1, wherein determining an acceleration profile comprises:
determining the acceleration profile with a deceleration phase for decreasing the velocity of the ego vehicle compared to the preceding third party vehicle on the ego lane,
wherein the deceleration phase is subsequent to the acceleration phase,
wherein a deceleration of the deceleration phase is determined based on the preceding third party vehicle on the ego lane, a maximum deceleration value and a maximum change of acceleration with at least a minimum deceleration to keep at least a minimum distance to the preceding third party vehicle.

7. The method according to claim 6, wherein determining the acceleration profile with a deceleration phase comprises:
determining a current distance of the ego vehicle to the preceding third party vehicle on the ego lane; and
determining the deceleration phase based on the determined current distance of the ego vehicle to the preceding third party vehicle on the ego lane.

8. The method according to claim 6, wherein determining the deceleration of the deceleration phase based on the preceding third party vehicle on the ego lane, a maximum deceleration value and a maximum change of acceleration with at least a minimum deceleration to keep at least a minimum distance to the preceding third party vehicle comprises:
determining the deceleration of the deceleration phase based on passive braking,
wherein a deceleration performed using engine breaking of the ego vehicle, a deceleration based on air resistance and/or rolling resistance of the ego vehicle, and/or a deceleration based on energy recuperation performed with the ego vehicle, or based on active braking, using a conventional braking system of the ego vehicle.

9. The method according to claim 6, wherein determining the deceleration of the deceleration phase based on the preceding third party vehicle on the ego lane, a maximum deceleration value and a maximum change of acceleration with at least a minimum deceleration to keep at least a minimum distance to the preceding third party vehicle comprises:
determining the deceleration as a minimum deceleration to reach a minimum distance with a target velocity smaller than the velocity of the preceding third party vehicle on the ego lane with a predefined relative velocity offset.

10. The method according to claim 6, wherein determining an acceleration profile comprises:
determining the acceleration profile with a return phase for returning with the ego vehicle into a driving modus for following the preceding third party vehicle on the ego lane with the initial distance between the ego vehicle and the preceding third party vehicle on the ego lane, wherein the return phase is subsequent to the deceleration phase.

11. The method according to claim 1, further comprising:
performing a continuous recalculation of the acceleration and/or deceleration of the acceleration profile, in particular after expiry of a given time period.

12. A driving support system for use in an ego vehicle for following a preceding third party vehicle,
wherein performing adaptive cruise control, when driving on a road with multiple driving lanes for driving in a forward driving direction of the ego vehicle,
wherein the driving support system is adapted to perform the method for pre-boost acceleration prior to overtaking a preceding third party vehicle according to claim 1.
